(19) United States
(12) Patent Application Publication
(10) Pub. No.: US 2013/0064621 A1
(43) Pub. Date: Mar. 14, 2013

(54) Adjustable Cargo Bar

(71) Applicant: Gang Wang, Shanghai (CN)

(72) Inventor: Gang Wang, Shanghai (CN)

(73) Assignee: SHANGHAI ITPC HARDWARE CO., LTD., Shanghai (CN)

(21) Appl. No.: 13/242,689

(22) Filed: Sep. 23, 2011

(30) Foreign Application Priority Data
Sep. 8, 2011 (CN) 201110265367.2

(51) Int. Cl. B60P 7/14

(52) U.S. Cl. 410/130; 410/129

(57) ABSTRACT

An adjustable cargo bar applied to a cargo bed of pickup trucks and comprising: a frame element; at least one adjusting element coupled to the frame element, for adjusting the width of the adjustable cargo bar; at least one elevation element, for raising the height of the cargo bar, so that the width and height of the cargo bar can be adjusted to fit different models of pickup trucks and serve as a good life helper for household use, traveling and camping.

### CROSS-REFERENCE TO RELATED APPLICATION

This application claims the benefit of China Patent Application No. 201110265367.2, filed on Sep. 8, 2011, in the China Intellectual Property Office the disclosure of which is incorporated herein by reference.

### BACKGROUND OF THE INVENTION

1. Field of the Invention

The present invention relates to a cargo bar, in particular to the cargo bar with adjustable width and height to fit different pickup trucks.

2. Description of the Related Art

Pickup truck is used more extensively day after day in our life, and generally used for traveling, camping, and moving. When cargos are not filled up in the cargo bed, the cargos may be damaged easily in a bumpy road condition. Therefore, various types of cargo bars for pickup trucks are available in the market. However, present existing cargo bars for pickup trucks just allow users to adjust the width only and fail to fit different models of pickup trucks with different heights, and the conventional cargo bars do not provide a secured fixation.

### SUMMARY OF THE INVENTION

In view of the aforementioned problems of the conventional cargo bar, it is a primary objective of the present invention to provide an adjustable cargo bar to overcome the problems of the prior art.

To achieve the foregoing objective, the present invention provides an adjustable cargo bar applied in a cargo bed of a pickup truck, comprising: a frame element; at least one adjusting element coupled to the frame element for adjusting the width of the adjustable cargo bar; and at least one elevation element for adjusting the height of the cargo bar.

Wherein, at least one end of the frame element is coupled to a fixing element and matched to the cargo bed of the pickup truck.

Wherein, the elevation element is a screw structure, a ratchet structure, a winch structure or a combination thereof

Wherein, the adjusting element is a screw structure, a ratchet structure, a winch structure or a combination thereof

Wherein, the adjustable cargo bar further comprises a chassis element movably coupled to the frame element and the elevation element.

Wherein, the chassis element includes a first guide rail matched with a second guide rail of the frame element.

Wherein, the second guide rail is sheathed on the first guide rail.

Wherein, the elevation element is fixed to the frame element and coupled to the chassis element.

Wherein, the frame element includes an outer frame coupled to a plurality of horizontal support rods and a plurality of vertical support rods.

Wherein, the outer frame is comprised of two first support frames, a second support frame and a third support frame.

With the aforementioned technical solution, the width and height of the adjustable cargo bar of the present invention can be adjusted to fit different models of pickup trucks and serve as a good life helper for household use, traveling and camping.

### BRIEF DESCRIPTION OF THE DRAWING

FIG. 1 is a schematic view of a structure of the present invention;

FIG. 2 is a partial exploded view of a frame element and a chassis element of the present invention;

FIG. 3 is a schematic view of rotating an adjusting element outwardly in accordance with the present invention; and

FIG. 4 is a schematic view of an elevating structure of an elevation element in accordance with the present invention.

### DESCRIPTION OF THE PREFERRED EMBODIMENTS

The technical characteristics of the present invention will become apparent by the detailed description of a preferred embodiment and the illustration of related drawings as follows.

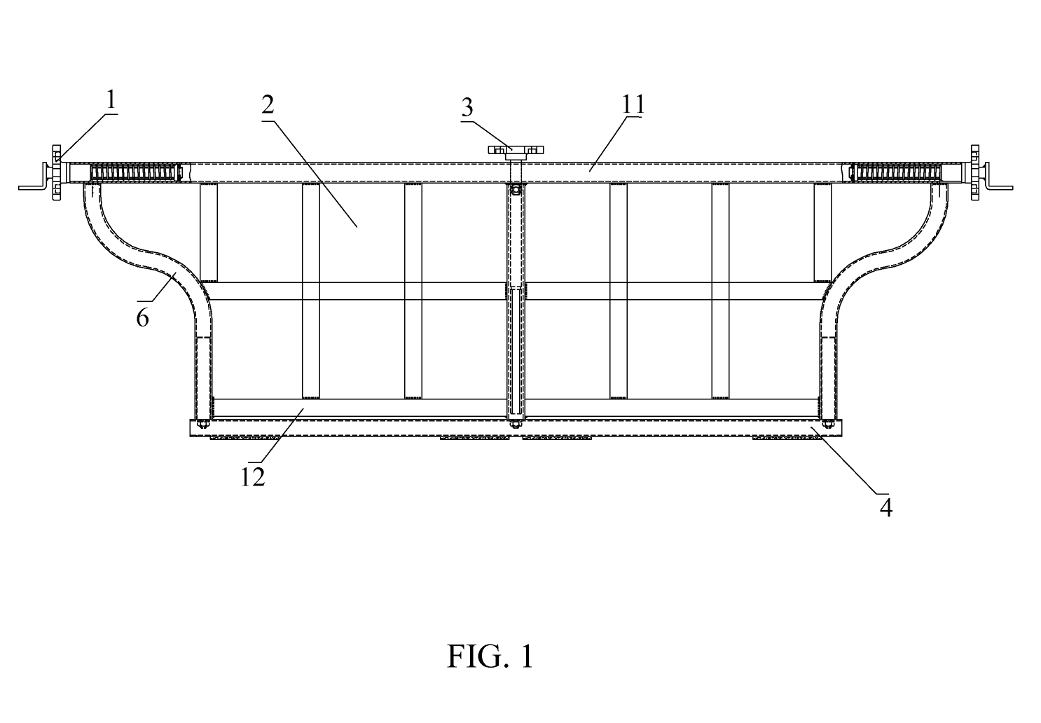

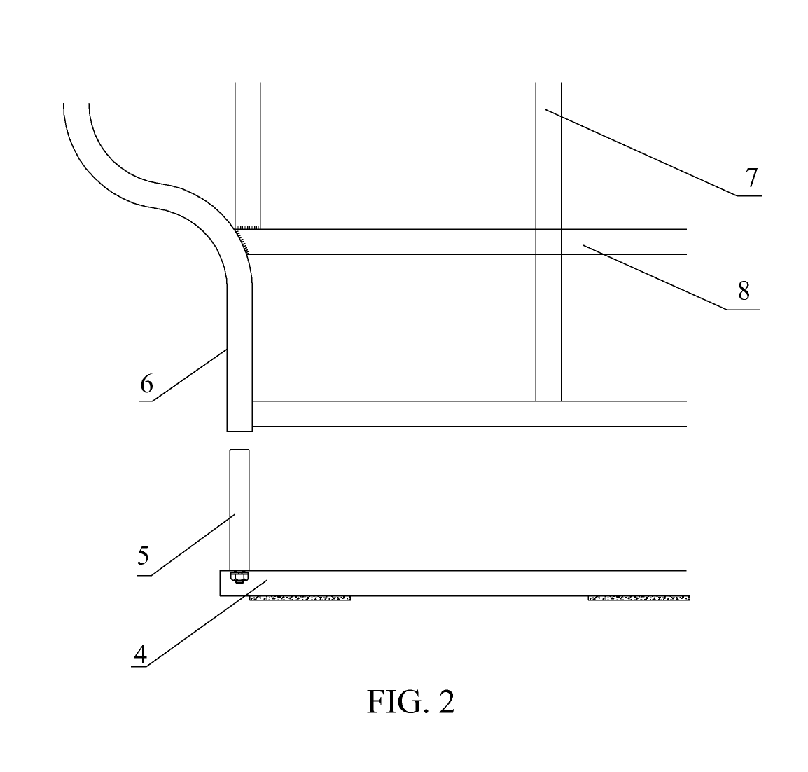

With reference to FIGS. 1 to 4 for an adjustable cargo bar applied in a cargo bed of a pickup truck, the adjustable cargo bar comprises a frame element 2 including an elevation element 3 for adjusting the height of the cargo bar to fit different models of cargo beds of the pickup trucks, and the elevation element can be a screw, ratchet, or winch structure. In this preferred embodiment, the screw structure is adopted, and the elevation element 3 includes at least one screw fixed to the frame element 2 and coupled to the chassis element 4. The frame element 2 includes a plurality of fixing elements 10 installed at both ends of the frame element 2 and corresponding to the cargo bed of the pickup truck for fixing the adjustable cargo bar to the cargo bed of the pickup truck securely. In this preferred embodiment, the fixing elements 10 are L-shaped fixing elements.

The frame element 2 is coupled to at least one adjusting element 1, and the adjusting element 1 is provided for adjusting the width of the cargo bar, so that the adjusting cargo bar can be matched with the width of the cargo bed of the pickup truck, and the adjusting element 1 can be a screw, ratchet, or winch structure. In this preferred embodiment, the adjusting element 1 is the screw structure. Both ends of the frame element 2 are coupled to an adjusting element 1, and the fixing element 10 is fixed to the screw adjusting handle 9.

The cargo bar further comprises a chassis element 4 movably coupled to the frame element 2. The chassis element 4 includes a first guide rail 5 matched with a second guide rail of the frame element 2, and the second guide rail is sheathed on and coupled to the first guide rail 5.

In this preferred embodiment, the frame element 2 includes a frame comprised of two first support frames 6, a second support frame 11 and a third support frame 12. The first support frame 6 includes a second guide rail, and the frame is coupled to a plurality of horizontal support rods 7 and a plurality of vertical support rods 8, and the horizontal support rods 7 and the vertical support rods 8 intersected with each other to form a grid structure.

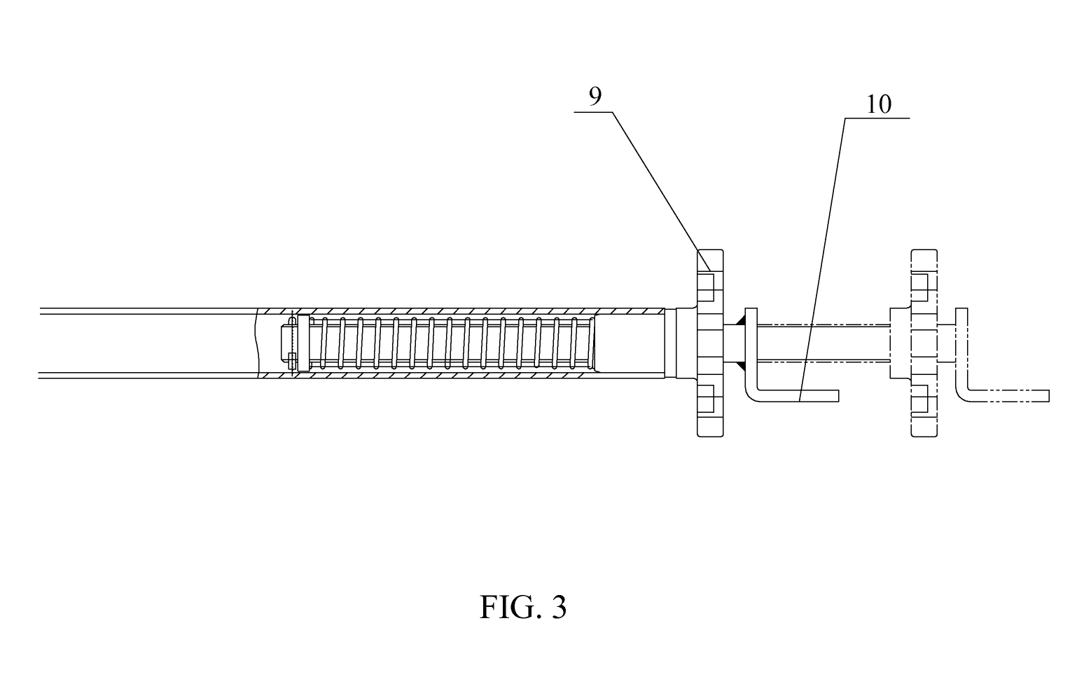

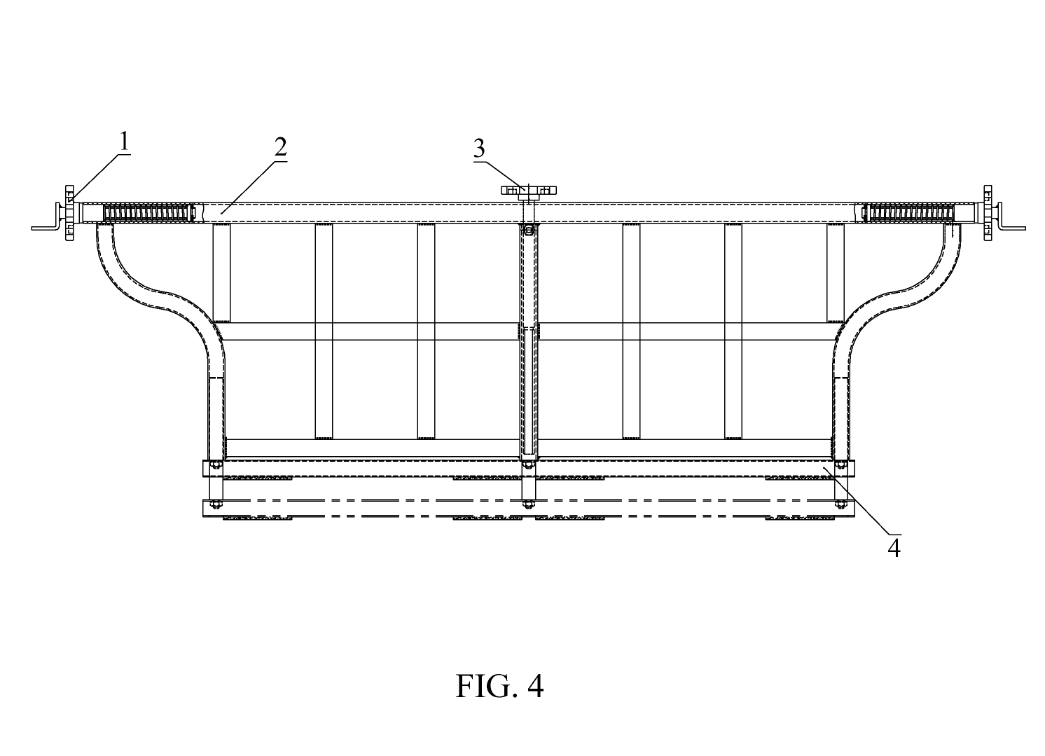

When use, the cargo bar is placed on a pickup truck, and the adjusting element 1 is adjusted to match the width of a cargo bed of the pickup truck. More specifically, the screw adjusting handle 9 is adjusted to a position indicated by the dotted line of FIG. 3 to match with the width of the cargo bed of the pickup truck, and the L-shaped fixing element 10 is matched with the cargo bed of the pickup truck. By adjusting the elevation element 3, the height of the cargo bar can be adjusted, and the chassis element 4 is elevated to a position as indicated by the dotted line in FIG. 4. By the elevation element 3, a larger supporting force is produced to latch with the cargo bed of the pickup truck securely.

While the invention has been described by means of specific embodiments, numerous modifications and variations could be made thereto by those skilled in the art without departing from the scope and spirit of the invention set forth in the claims.

What is claimed is:

1. An adjustable cargo bar, matched with a cargo bed of a pickup truck, comprising:
a frame element;
at least one adjusting element, coupled to the frame element, for adjusting the width of the adjustable cargo bar; and
at least one elevation element, for adjusting the height of the elevation element.

2. The adjustable cargo bar of claim 1, wherein at least one end of the frame element is coupled to a fixing element matched with the cargo bed of the pickup truck.

3. The adjustable cargo bar of claim 1, wherein the elevation element is a screw structure, a ratchet structure, a winch structure or a combination thereof

4. The adjustable cargo bar of claim 1, wherein the adjusting element is a screw structure, a ratchet structure, a winch structure or a combination thereof

5. The adjustable cargo bar of claim 1, further comprising a chassis element movably coupled to the frame element and the elevation element.

6. The adjustable cargo bar of claim 5, wherein the chassis element includes a first guide rail matched with a second guide rail of the frame element.

7. The adjustable cargo bar of claim 6, wherein the second guide rail is sheathed on the first guide rail.

8. The adjustable cargo bar of claim 3, wherein the elevation element is fixed to the frame element and coupled to the chassis element.

9. The adjustable cargo bar of claim 1, wherein the frame element includes an outer frame coupled to a plurality of horizontal support rods and a plurality of vertical support rods.

10. The adjustable cargo bar of claim 9, wherein the outer frame is comprised of two first support frames, a second support frame and a third support frame.
